(19) United States
(12) Patent Application Publication
(10) Pub. No.: US 2025/0035064 A1
(43) Pub. Date: Jan. 30, 2025

(54) Piston with Vaulted Cooling Chamber

(71) Applicant: Delta Hawk Engines, Inc., Racine, WI (US)

(72) Inventors: Collin Balcer, Racine, WI (US); Aaron Gamache Foege, Kansasville, WI (US); Graydon Robert Hegge, Madison, WI (US)

(21) Appl. No.: 18/784,328

(22) Filed: Jul. 25, 2024

Related U.S. Application Data
(60) Provisional application No. 63/515,920, filed on Jul. 27, 2023.

(51) Int. Cl. F02F 3/22; F02F 3/00

(52) U.S. Cl. CPC F02F 3/22; F02F 3/0015

(57) ABSTRACT

A piston assembly is provided with a vaulted cooling chamber defined between the piston head and the piston skirt. The vaulted cooling chamber includes an inner gallery, an outer gallery, and a plurality of channels which connect the inner gallery to the outer gallery. In certain embodiments, the plurality of channels circumferentially extends at least 120 degrees around the longitudinal axis. In other certain embodiments, the piston assembly further includes a plurality of walls which define the plurality of channels, and there are at least four walls. In other certain embodiments, the piston head is coupled to the piston skirt by a plurality of fasteners, and each of the fasteners is located within 45 circumferential degrees of a fastener axis.

### CROSS-REFERENCE TO RELATED PATENT APPLICATION

The present application claims the benefit of and priority to U.S. Provisional Application No. 63/515,920 filed on Jul. 27, 2023, which is incorporated herein by reference in its entirety.

### BACKGROUND OF THE INVENTION

The present invention relates generally to the field of engines. The present invention relates specifically a vaulted cooling chamber for a piston in a two-stroke internal combustion engine.

### SUMMARY OF THE INVENTION

One embodiment of the invention relates to a piston assembly including a piston skirt and a piston head. The piston skirt extends along a longitudinal axis from a first end to a second end. The piston head is coupled to the first end of the piston skirt by a plurality of fasteners. When coupled together, the piston skirt and piston head define an inner gallery and an outer gallery. The inner gallery is located radially closer to the longitudinal axis of the piston skirt than the plurality of fasteners. The outer gallery is located radially further from the longitudinal axis than the inner gallery and the plurality of fasteners. The piston includes an inlet for providing fluid communication for oil between an area within the piston skirt and the outer gallery. The piston assembly further includes a plurality of channels providing fluid communication between the inner gallery and the outer gallery. Collectively, the plurality of channels circumferentially extends at least 120 degrees around the longitudinal axis. Oil then exits the piston assembly through an outlet providing fluid communication between the outer gallery and the area within the piston skirt.

Another embodiment of the invention relates to a piston assembly for an internal combustion engine. The piston assembly includes a piston skirt and a piston head. The piston skirt extends along a longitudinal axis from a first end to a second end. The first end of the piston skirt faces a combustion chamber of a cylinder of the internal combustion engine, while the second end extends away from the combustion chamber. The piston head is coupled to the first end of the piston skirt and moves within the combustion chamber. An inner gallery and an outer gallery are defined between the piston skirt and the piston head. The inner gallery is located radially closer to the longitudinal axis of the piston skirt than the plurality of fasteners. The outer gallery is located radially further from the longitudinal axis than the inner gallery and the plurality of fasteners. The piston assembly includes an inlet providing fluid communication for oil between a crankcase of the engine and the outer gallery. The piston assembly further includes a plurality of walls. The plurality of walls extends from a surface of the piston head towards the first end of the piston skirt. The plurality of walls defines a partial barrier between the inner gallery and the outer gallery. The plurality of walls further defines a plurality of channels which provide fluid communication between the inner gallery and the outer gallery. In the piston assembly, there are at least four walls in the plurality of walls. An outlet providing fluid communication between the outer gallery and the crankcase allows for oil to exit the piston assembly.

Another embodiment of the invention relates to a piston assembly including a piston skirt and a piston head. The piston skirt extends along a longitudinal axis from the first end to a second end and includes a wrist pin bore located between the first end and the second end. The first end faces a combustion chamber of an engine, and the second end faces away from the combustion chamber towards the crankcase of an engine. The piston head is coupled to the piston skirt at the first end. The wrist pin bore extends through the piston skirt along a wrist pin axis. The wrist pin axis intersects the longitudinal axis. The piston assembly further includes a plurality of fasteners and a fastener axis. The fastener axis is perpendicular to the wrist pin axis and perpendicular to the longitudinal axis. The plurality of fasteners couples the piston head to the piston skirt. Each of the fasteners in the plurality of fasteners is within 45 circumferential degrees of the fastener axis with respect to the longitudinal axis. The piston skirt and piston head when coupled together define an inner gallery and an outer gallery. The inner gallery is located radially closer to the longitudinal axis of the piston skirt than the plurality of fasteners, while the outer gallery is located radially further from the longitudinal axis than the inner gallery and the plurality of fasteners. The piston assembly includes an inlet for providing fluid communication for oil between an area within the piston skirt and the outer gallery. The piston assembly further includes a plurality of channels that is located between the inner gallery and the outer gallery. The plurality of channels provides fluid communication between the inner gallery and the outer gallery. Oil then exits the piston assembly through an outlet providing fluid communication between the outer gallery and the area within the piston skirt.

Additional features and advantages will be set forth in the detailed description which follows and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is an isometric view of a two-stroke combustion engine in an inverted V-block orientation, according to an exemplary embodiment.

FIG. 2 is a front cross-sectional view of a portion of the engine shown in FIG. 1 according to an exemplary embodiment.

FIG. 3 is a front perspective view of a piston assembly including a piston head and a piston skirt, according to an exemplary embodiment.

FIG. 4 is a front perspective cross-sectional view of the piston assembly of FIG. 3, according to an exemplary embodiment.

FIG. 5 is a front plan cross-sectional view of the piston assembly of FIG. 3, according to an exemplary embodiment.

FIG. 6 is a front perspective view of the piston skirt of FIG. 3, according to an exemplary embodiment.

FIG. 7 is a top plan view of the piston skirt of FIG. 3, according to an exemplary embodiment.

FIG. 8 is a bottom perspective view of the piston head of FIG. 3, according to an exemplary embodiment.

FIG. 9 is a bottom plan view of the piston head of FIG. 3, according to an exemplary embodiment.

FIG. 10 is a front perspective exploded view of the piston assembly of FIG. 3, according to an exemplary embodiment.

FIG. 11 is a is a bottom perspective exploded view of the piston assembly of FIG. 3, according to an exemplary embodiment.

### DETAILED DESCRIPTION

Referring generally to the figures, various embodiments of a piston assembly with a vaulted cooling chamber are shown. In an internal combustion engine, the piston assembly reciprocates into the combustion chamber and ignites a fuel and air mixture resulting in high heat and pressure. The heat generated can cause the piston assembly to expand if not cooled down, which may lead to the piston assembly becoming less efficient. The pressure generated from combustion loading is transferred from the piston head to the piston skirt, which may cause the piston skirt to deform when the piston skirt is made from a material with a lower stiffness than the piston head.

Applicant has developed various piston assemblies that are believed to provide for various advantages over typical piston assemblies, including increased piston integrity and more efficient piston cooling. Specifically, the piston assemblies discussed herein utilize a vaulted cooling chamber. The vaulted cooling chamber increases integrity by utilizing walls between a plurality of channels that assist in the transfer of combustion loading from the piston head to the piston skirt. Additionally, the vaulted cooling chamber allows for cooling by providing a flow path for oil to flow from the crankcase of the engine through an inner gallery, an outer gallery, and a plurality of channels of the piston assembly.

The vaulted cooling chamber provides increased piston integrity and increased cooling efficiency even when the piston skirt is made with a material with a lower stiffness than the material of the piston head. For example, a piston skirt fabricated from aluminum coupled to a piston head fabricated from steel.

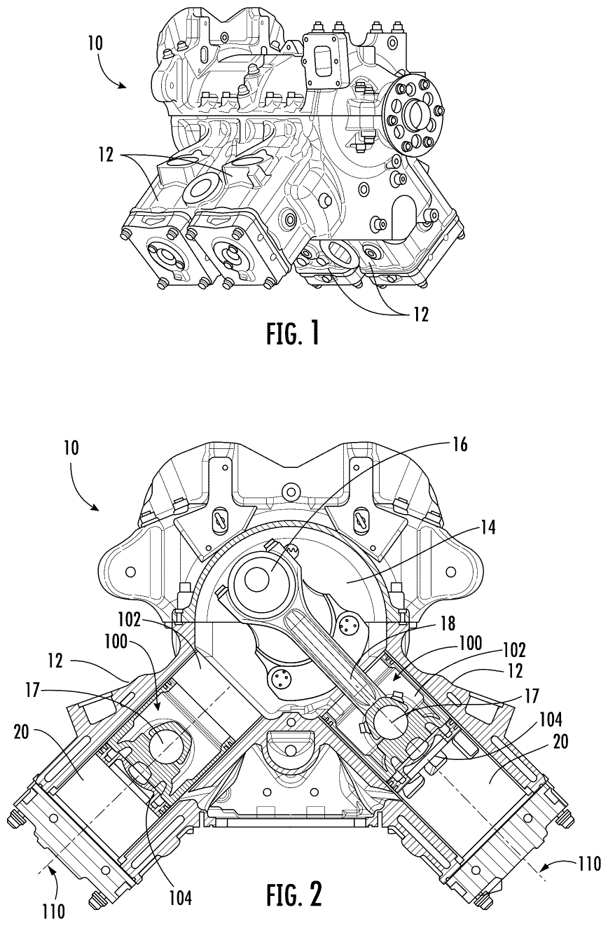

Referring to FIG. 1, an engine 10 is shown according to an exemplary embodiment. As shown in FIG. 1, engine 10 is an internal combustion engine. More specifically, engine 10 is a two-stroke diesel engine that is oriented in an inverted V-block configuration. Engine 10 includes cylinders 12 which are positioned on a lower or bottom side of engine 10.

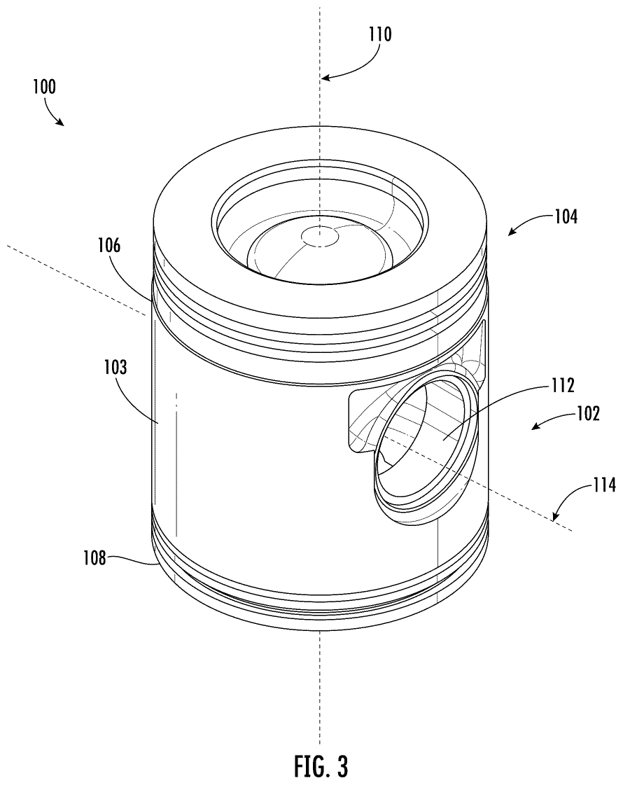

Referring to FIG. 2, two cylinders 12 of engine 10 are shown. Each cylinder 12 is coupled to crankcase 14 of engine 10. Each cylinder 12 is centered on and extends away from crankcase 14 in a generally downward direction along an axis 110. Within each cylinder 12 is a piston assembly 100. Each piston assembly 100 is located between combustion chamber 20 and crankcase 14. When mounted in engine 10, each piston assembly 100 extends along and is centered on axis 110. Each piston assembly 100 is connected to a crankshaft 16 through connecting rod 18. Connecting rod 18 extends from wrist pin 17 to crankshaft 16 located in crankcase 14. Connecting rod 18 and wrist pin 17 allow each piston assembly 100 to travel axially within cylinder 12 as crankshaft 16 is rotated within crankcase 14.

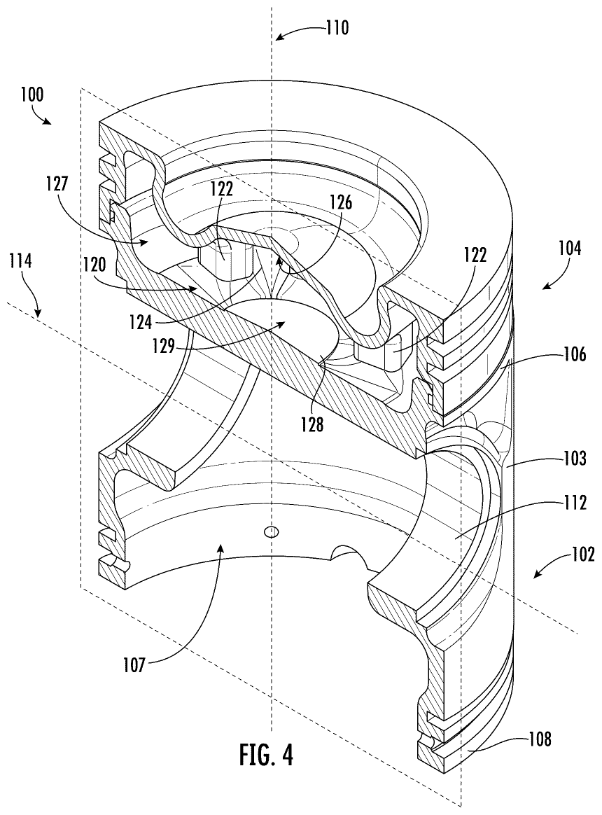

Referring to FIG. 3, a piston assembly 100 is shown, according to an exemplary embodiment. Piston assembly 100 is configured for use in an internal combustion engine. Though discussed namely in the context of two-stroke diesel engine 10, the piston assemblies described are further applicable to other piston engines. Piston assembly 100 can reciprocate within a cylinder 12 of engine 10 between combustion chamber 20 and crankcase 14. Piston assembly 100 initiates combustion of an air and fuel mixture within combustion chamber 20, which provides a force used to rotate crankshaft 16 of engine 10.

As shown, piston assembly 100 includes a piston skirt 102 and a piston crown or piston head 104. Piston skirt 102 is configured to stabilize piston assembly 100 as piston assembly 100 reciprocates through cylinder 12. Piston skirt 102 has an outer surface 103 that defines a cylindrical shape of piston skirt 102. Piston skirt 102 has a first end 106 and a second end 108 opposite first end 106. Piston skirt 102 extends along and is centered on longitudinal axis 110 from first end 106 to second end 108. When piston assembly 100 is housed in cylinder 12, first end 106 is located closer to combustion chamber 20 along longitudinal axis 110, and second end 108 is located closer to crankcase 14 along longitudinal axis 110.

Piston head 104 is coupled to piston skirt 102 at first end 106. Piston head 104 and piston skirt 102 are coupled to each other through threading and a plurality of fasteners 130. Piston head 104 is configured to receive the threaded end of a plurality of fasteners 130 within head bores 144. First end 106 of piston skirt 102 includes skirt bores 143. Piston skirt 102 is configured such that the threaded end of the plurality of fasteners 130 may pass through skirt bores 143 into head bores 144, but the driving end of the plurality of fasteners 130 abuts against first end 106, which keeps the fasteners 130 in place. By torquing fasteners 130 through head bores 144, the fasteners 130 develop a force that presses piston skirt 102 into piston head 104. As such, piston skirt 102 and piston head 104 are rigidly coupled together. Piston head 104 moves within combustion chamber 20 and is configured to transmit compression forces generated during combustion of a fuel and air mixture through piston assembly 100 to crankshaft 16 of engine 10. Piston head 104 is generally cylindrical-shaped and is centered on longitudinal axis 110.

Piston assembly 100 further includes a wrist pin bore 112. Wrist pin bore 112 extends through piston skirt 102 and is located between first end 106 and second end 108. Wrist pin bore 112 is configured to receive wrist pin 17 which is used to couple piston assembly 100 to connecting rod 18. Connecting rod 18 is connected to crankshaft 16 and transfers the force generated by combustion from piston head 104 to crankshaft 16. Wrist pin bore 112 is generally circular and extends through piston skirt 102 along a wrist pin axis 114. Wrist pin axis 114 intersects longitudinal axis 110. As shown, wrist pin axis 114 is perpendicular to longitudinal axis 110.

Piston head 104 is made from a first material and piston skirt 102 is made from a second material. In a specific embodiment, the first material has a greater stiffness than the second material. More specifically, both the first material and the second material are made from metals, where the first material includes steel, and the second material includes aluminum.

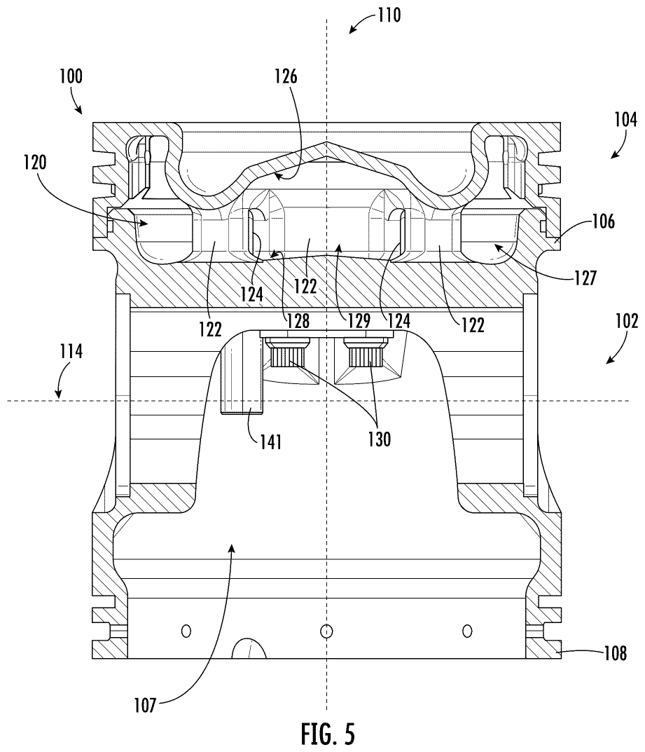

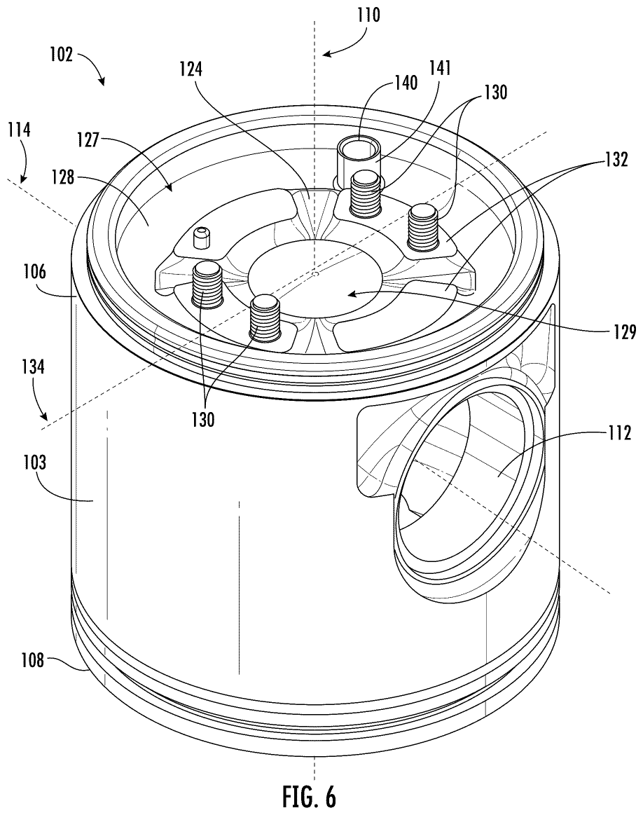

Referring to FIGS. 4 and 5, a cross-section of piston assembly 100 is shown. Piston assembly 100 includes vaulted cooling chamber 120 located between piston skirt 102 and piston head 104. When coupled together, piston skirt 102 and piston head 104 define vaulted cooling chamber 120. Vaulted cooling chamber 120 includes a plurality of walls 122 and a plurality of channels 124. As previously discussed, walls 122 provide for increased integrity between piston head 104 and piston skirt 102 allowing for the transfer of combustion loading from piston head 104 to piston skirt 102. The plurality of channels 124 provide for increase cooling efficiency in vaulted cooling chamber 120 by increasing the surface area of vaulted cooling chamber 120 and by providing improved fluid communication between an outer gallery 127 and an inner gallery 129.

Vaulted cooling chamber 120 is located between an inside surface 126 of piston head 104 and a top surface 128 of piston skirt 102. Top surface 128 is located at first end 106 of piston skirt. Inside surface 126 of piston head 104 faces first end 106 and faces top surface 128. Plurality of channels 124 allows for more surface area of inside surface 126 and top surface 128 to be contacted by oil that enters vaulted cooling chamber 120. As such, the increased surface area allows for more efficient removal of heat from within piston assembly 100.

Plurality of channels 124 provides fluid communication between outer gallery 127 and inner gallery 129. Outer gallery 127 defines an outer portion of vaulted cooling chamber 120 and is defined between piston skirt 102 and piston head 104. Outer gallery 127 is defined by the area of vaulted cooling chamber 120 positioned between outer surface 103 of piston assembly and the portion of walls 122 spaced furthest from longitudinal axis 110, or outer side surface of walls 122. Inner gallery 129 defines an inner portion of vaulted cooling chamber 120 and is defined between piston skirt 102 and piston head 104. Inner gallery 129 is defined by the area of vaulted cooling chamber 120 positioned between longitudinal axis 110 and the portion of walls 122 closest to longitudinal axis, or inner side surface of walls 122. In this way, inner gallery 129 is radially surrounded by walls 122 and outer gallery 127. Collectively, plurality of channels 124, outer gallery 127, and inner gallery 129 define vaulted cooling chamber 120. By utilizing plurality of channels 124 between inner gallery 129 and outer gallery 127, galleries 127 and 129 are no longer distinct but, instead, have a shared surface area, which allows for oil to remove heat more efficiently from piston 100.

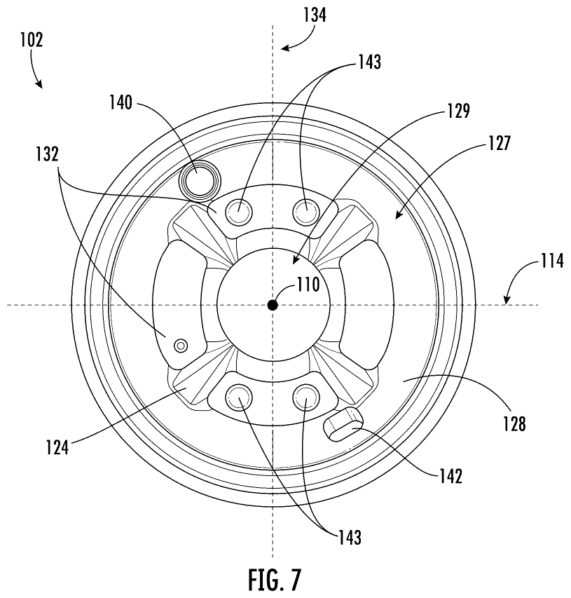

Referring to FIGS. 6 and 7, piston skirt 102 is shown according to an exemplary embodiment. Specifically, top surface 128 of piston skirt 102 is shown. Top surface 128 includes a plurality of bolts or fasteners 130 extending through skirt bores 143 and a plurality of pads 132.

Plurality of fasteners 130 is configured to couple piston skirt 102 to piston head 104. Plurality of fasteners 130 extends through top surface 128 in a direction parallel to the longitudinal axis. Fasteners 130 are spaced to allow for a wrist pin bushing to be used with a wrist pin in wrist pin bore 112. This is particularly useful for a two-stroke internal combustion engine, which undergoes higher wrist pin loading than some other engines.

In certain embodiments, fasteners 130 are spaced approximately orthogonal to the wrist pin axis; that is, each fastener 130 is located within 90 circumferential degrees of the wrist pin axis 114 with respect to longitudinal axis 110. More specifically, each fastener 130 is between 80 degrees and 70 degrees of the wrist pin axis 114. In certain embodiments, each fastener 130 is located at least 70 degrees from wrist pin axis 114. Additionally, a fastener axis 134 is oriented perpendicular to wrist pin axis 114 and perpendicular to longitudinal axis 110. In certain embodiments, each fastener 130 is located within 45 circumferential degrees of fastener axis 134 with respect to longitudinal axis 110. More specifically, each fastener 130 is within 30 circumferential degrees of fastener axis 134 with respect to longitudinal axis 110.

As shown, plurality of fasteners 130 includes a first pair of fasteners and a second pair of fasteners. The pairs are spaced circumferentially and bilaterally away from each other with respect to longitudinal axis 110. In certain embodiments, the first pair of fasteners is spaced at least 110 degrees from the second pair of fasteners. More specifically, the first pair of fasteners is spaced between 120 degrees and 130 degrees from the second pair of fasteners.

Plurality of pads 132 extend away from top surface 128 in a direction parallel to longitudinal axis 110. When piston skirt 102 is coupled to piston head 104, plurality of pads 132 extend towards piston head 104. Plurality of pads 132 are spaced from each other by a distance and are arranged to radially surround longitudinal axis 110. Pads 132 define a partial barrier between each of plurality of channels 124. Pads 132 include sloping outer walls, which allow for channels 124 to have a rounded shape along top surface 128. In certain embodiments, plurality of pads 132 includes at least four pads (e.g., four pads, more than four pads, six pads, more than six pads).

As shown, outer gallery 127 is partially defined by plurality of pads 132 and outer surface 103 of piston assembly 100. Outer gallery 127 is located radially further from longitudinal axis 110 than plurality of fasteners 130. Also, inner gallery 129 is partially defined by plurality of pads 132. Inner gallery 129 is located radially closer to longitudinal axis 110 than plurality of fasteners 130 and outer gallery 127.

Together, inner gallery 129 and outer gallery 127 define a gallery surface area measured along inside surface 126. Additionally, plurality of channels 124 define a channel surface area along inside surface 126 between inner gallery 129 and outer gallery 127. In certain embodiments, channel surface area is at least 20% of the gallery surface area. More specifically, the channel surface area is at least 30% of the gallery surface area.

Additionally, inner gallery 129 and outer gallery 127 further define a gallery cross-sectional area along a plane perpendicular to longitudinal axis 110. In particular, the plane is perpendicular to longitudinal axis 110 and parallel to fastener axis 134. As shown, the plane extends in a direction that defines the largest area for one or both of the inner gallery and/or the outer gallery. Plurality of channels 124 define a channel cross-sectional area along the plane perpendicular to longitudinal axis 110. In certain embodiments, a ratio of gallery cross-sectional area to channel cross-section area is 1:12 to 1:4. In a specific embodiment, the ratio of gallery cross-sectional area to channel cross-section area is 1:6.

Referring to FIG. 7, plurality of channels 124 is shown with at least four channels. Plurality of channels 124 radially extend around longitudinal axis 110, and plurality of pads 132 define a partial barrier between each channel 124. As shown, each channel 124 has a tapered shape. That is, each channel 124 includes a first portion and a second portion. The first portion is radially closer to outer surface 103, while the second portion is radially closer to longitudinal axis 110. The first portion has a greater cross-sectional area than the second portion assisting oil in being directed towards inner gallery 129.

In certain embodiments, plurality of channels 124 collectively define a distance that circumferentially extends at least 120 degrees around longitudinal axis 110. More specifically plurality of channels 124 collectively extends circumferentially around the longitudinal axis 110 by 120 degrees to 140 degrees. In certain embodiments, each channel of plurality of channels 124 extends a circumferential distance around longitudinal axis 110 of 15 degrees to 30 degrees. More specifically, each channel 124 extends 20 degrees to 25 degrees. Additionally, each channel 124 may extend the same distance as each other.

In other certain embodiments, each channel 124 in plurality of channels 124 is spaced by a circumferential distance of at least 15 degrees from each other. More specifically, each channel 124 is spaced by at least 20 degrees from each other.

As shown in FIGS. 5-7, piston skirt 102 further includes an inlet 140 and outlet port or outlet 142. Inlet 140 provides fluid communication for oil between crankcase 14 of engine 10 and vaulted cooling chamber 120. More specifically, inlet 140 is located in outer gallery 127, and inlet 140 provides fluid communication for oil between an area 107 of piston skirt 102 and the outer gallery 127. Oil that flows through inlet 140 enters vaulted cooling chamber 120 through outer gallery 127. The oil then moves from outer gallery 127 through plurality of channels 124 into inner gallery 129. The oil then moves back through channels 124 and into outer gallery 127 and exits vaulted cooling chamber 120 through outlet 142. In this way, outlet 142 provides fluid communication between outer gallery 127 and crankcase 14. More specifically, outlet 142 provides fluid communication for oil between outer gallery 127 and area 107 within piston skirt 102.

As shown, inlet 140 includes inlet tube 141. Inlet tube 141 is a cylinder that extends through top surface 128 into vaulted cooling chamber 120. Inlet tube 141 is fastened within area 107 within piston skirt 102 to assist oil in entering vaulted cooling chamber 120 through inlet 140. Specifically, a fixed oil jet or nozzle (not shown) directs a pressurized oil stream towards inlet 140 and through tube 141. The oil jet is preferably aligned with a central axis defined by an inside surface of tube 141. So, as piston assembly 100 oscillates, the stream of oil flows into inlet 140 through vaulted cooling chamber 120 and out through outlet 142.

In certain embodiments, inlet 140 and outlet 142 are positioned approximately 180 degrees from each other. More specifically, inlet 140 and outlet 142 are located between 170 and 180 degrees from each other. As shown in FIG. 7, inlet 140 and outlet 142 are positioned proximate to fasteners 130. Additionally, inlet 140 and outlet 142 are positioned such that they do not centrally align with channels 124. Plurality of pads 132 defines a partial barrier which block inlet 140 and outlet 142 from opening directly into channels 124. In certain specific embodiments, outlet 142 extends a circumferential distance of less than ten degrees past one of plurality of pads 132 and in front of one of plurality of channels 124. This allows an opening of less than ten degrees to be aligned with one of plurality of channels 124. More specifically, outlet 142 extends a circumferential distance less than five degrees past one of the plurality of pads 132. In a similar way, in certain embodiments, inlet 140 extends a circumferential distance of less than ten degrees past one of plurality of pads 132 and in front of one of plurality of channels 124. More specifically, inlet 140 extends a circumferential distance less than five degrees past one of the plurality of pads 132.

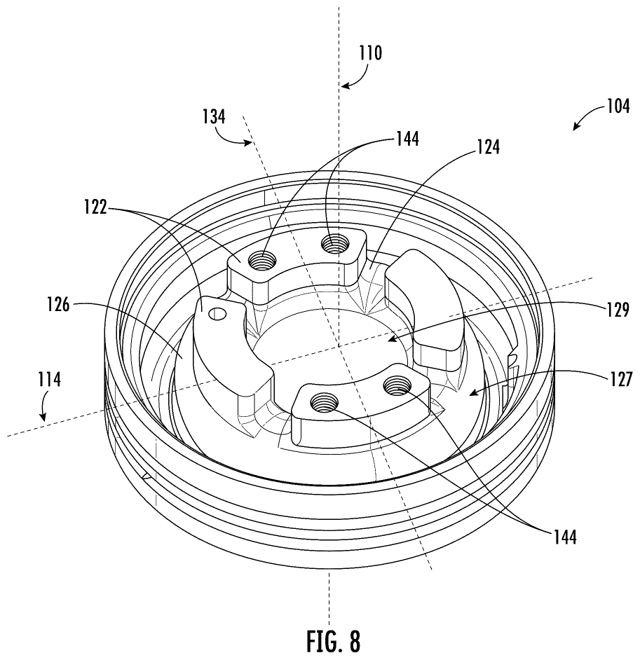

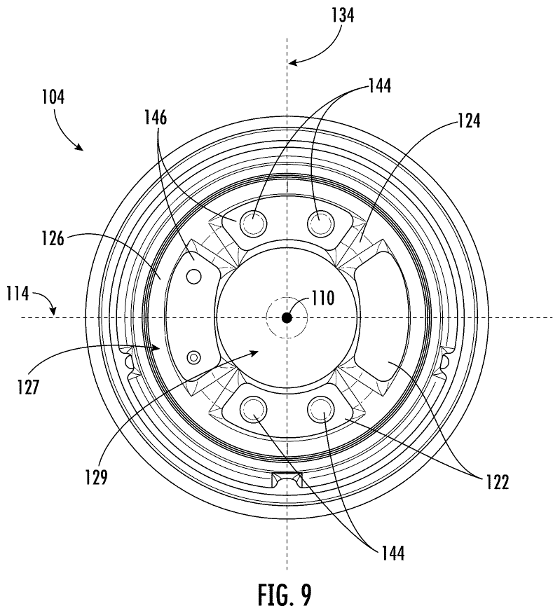

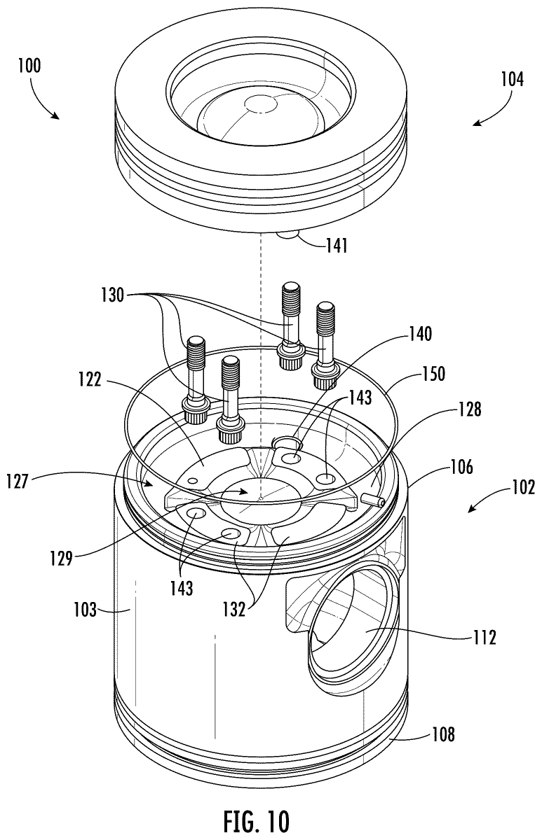

Referring to FIGS. 8 and 9, piston head 104 is shown according to an exemplary embodiment. Piston head 104 is configured to be coupled to piston skirt 102. As shown, plurality of walls 122 extend from inside surface 126 of piston head 104 in a direction parallel to longitudinal axis 110. When piston head 104 is coupled to piston skirt 102, plurality of walls 122 extend from inside surface 126 towards piston skirt 102 and, more specifically, towards plurality of pads 132. Plurality of walls 122 is configured to receive plurality of fasteners 130. In this way, plurality of fasteners 130 couple piston skirt 102 to piston head 104.

Like plurality of pads 132, plurality of walls 122 are spaced from each other by a distance and are arranged to radially surround longitudinal axis 110. Plurality of walls 122 define a partial barrier between inner gallery 129 and outer gallery 127 and partially define plurality of channels 124. Walls 122 include rounded edges and a curved base which allow for channels 124 to have a rounded shape along inside surface 126. As shown best in FIG. 9, plurality of walls 122 includes at least four walls. The at least four walls 122 define at least four channels 124.

In a certain embodiment, plurality of walls 122 collectively define a distance that circumferentially extends around longitudinal axis 110 less than 240 degrees. More specifically, plurality of walls 122 collectively extends 220 degrees to 240 degrees. In certain embodiments, each wall of plurality of walls 122 extends a circumferential distance around longitudinal axis 110 of at least 20 degrees and, more specifically, at least 25 degrees.

In certain other embodiments, each wall in plurality of walls 122 is spaced by a circumferential distance of at least 15 degrees from each other. More specifically, walls 122 are spaced from each other by 20 degrees to 30 degrees.

As shown, plurality of walls 122 includes a first set of walls 122 and a second set of walls 122. First set of walls 122 is configured to receive plurality of fasteners 130 and include head bores 144, which are shaped to receive fasteners 130. Second set of walls 122 are not configured to receive plurality of fasteners 130. Additionally, first set of walls extend a greater circumferential distance around longitudinal axis 110 than the second set of walls. In a specific embodiment, the first set of walls each extend around longitudinal axis 110 between 50 degrees and 80 degrees and, more specifically, between 65 degrees and 75 degrees, while the second set of walls each extend between 20 degrees to 65 degrees and, more specifically, between 20 degrees and 40 degrees.

Each wall of the plurality of walls 122 further includes a top surface 146 that extend along a plane perpendicular to longitudinal axis 110 and substantially parallel to inside surface 126. Collectively, top surfaces 146 define a wall surface area. Collectively, plurality of channels 124 define the channel surface area along inside surface 126 of piston head 104. In a certain embodiment, the ratio of wall surface area to channel surface area is at least 1:1.25. More specifically, the ratio of wall surface area to channel surface area is at least 1:2.

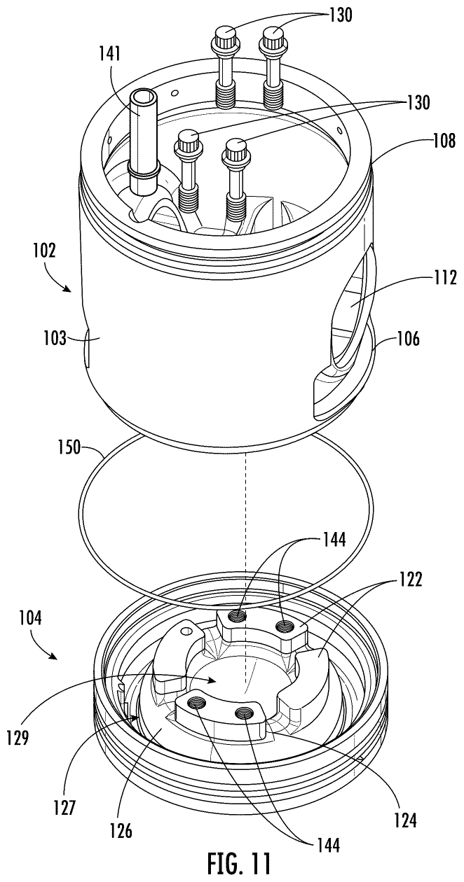

Referring to FIGS. 10 and 11, exploded views of piston assembly 100 are shown. Piston head 104 and piston skirt 102 are both centered and extend along longitudinal axis 110. Inlet tube 141 is shown displaced from piston skirt 102 from which it is mounted. Plurality of walls 122 and plurality of pads 132 extend towards each other and are coupled together through plurality of fasteners 130. Plurality of fasteners 130 are shown displaced from piston skirt 102. When assembled, plurality of fasteners 130 are coupled to piston skirt 102 and extend through skirt bores 143 in top surface 128 to engage head bores 144. In this way, plurality of fasteners 130 connect plurality of pads 132 to plurality of walls 122. As shown, plurality of walls 122 and plurality of pads 132 are spaced similarly around longitudinal axis 110 such that each pad 132 has a matching a wall 122. So, plurality of walls 122 and plurality of pads 132 may be coupled together and define a barrier between each channel of plurality of channels 124.

In certain embodiments, plurality of walls 122 and plurality of pads 132 have the same size and shape as each other. As depicted, the shape is a trapezoid with rounded edges. Further, as shown, piston assembly 100 includes a sealing ring 150. Sealing ring 150 is an O-ring which assists in making a seal between piston skirt 102 and piston head 104 when they are coupled together. Scaling ring 150 is located between outer surface 103 of piston skirt 102 and an internal surface of piston head 104. More specifically, sealing ring 150 is positioned adjacent to the threading of piston skirt 102 and piston head 104.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A piston assembly, comprising:
a piston skirt extending along a longitudinal axis from a first end to a second end;
a piston head coupled to the first end of the piston skirt;
a plurality of fasteners coupling the piston head to the piston skirt;
an outer gallery defined between the piston skirt and the piston head, wherein the outer gallery is radially further from the longitudinal axis than the plurality of fasteners;
an inlet providing fluid communication for oil between an area within the piston skirt and the outer gallery;
an inner gallery defined between the piston skirt and the piston head, wherein the inner gallery is radially closer to the longitudinal axis than the plurality of fasteners;
a plurality of channels providing fluid communication between the inner gallery and the outer gallery, wherein the plurality of channels collectively circumferentially extends at least 120 degrees around the longitudinal axis; and
an outlet providing fluid communication between the outer gallery and the area within the piston skirt.

2. The piston assembly of claim 1, wherein each channel of the plurality of channels is spaced by a circumferential distance of at least 15 degrees from each other with respect to the longitudinal axis.

3. The piston assembly of claim 2, wherein each channel of the plurality of channels is spaced at least 20 degrees from each other with respect to the longitudinal axis.

4. The piston assembly of claim 1, wherein the inner gallery and the outer gallery collectively define a gallery cross-sectional area along a plane perpendicular to the longitudinal axis, and the plurality of channels collectively define a channel cross-sectional area along the plane perpendicular to the longitudinal axis, wherein a ratio of the gallery cross-sectional area to the channel cross-sectional area is between 1:12 to 1:4.

5. The piston assembly of claim 4, wherein the ratio is 1:6.

6. The piston assembly of claim 1, wherein the piston head comprises an inside surface facing the first end of the piston skirt, wherein the inner gallery and the outer gallery collectively define a gallery surface area measured along the inside surface of the piston head, and the plurality of channels collectively define a channel surface area measured along the inside surface of the piston head, wherein the channel surface area is at least 20% of the gallery surface area.

7. The piston assembly of claim 6, wherein the channel surface area is at least 30% of the gallery surface area.

8. A piston assembly for a two-stroke diesel engine, the piston assembly comprising:
a piston skirt extending along a longitudinal axis from a first end to a second end, the first end facing a combustion chamber and the second end facing away from the combustion chamber;
a piston head coupled to the first end of the piston skirt;
a plurality of fasteners coupling the piston head to the piston skirt;
an inner gallery defined between the piston skirt and the piston head, wherein the inner gallery is radially closer to the longitudinal axis than the plurality of fasteners;
an outer gallery defined between the piston skirt and the piston head, wherein the outer gallery is radially further from the longitudinal axis than the plurality of fasteners;
an inlet providing fluid communication for oil between a crankcase and the outer gallery;
a plurality of walls extending from a surface of the piston head towards the first end of the piston skirt, the plurality of walls defining a partial barrier between the inner gallery and outer gallery and defining a plurality of channels providing fluid communication for oil between the inner gallery and the outer gallery, wherein the plurality of walls comprises at least four walls; and
an outlet providing fluid communication for oil between the outer gallery and the crankcase.

9. The piston assembly of claim 8, wherein each of the plurality of walls includes a top surface extending along a plane perpendicular to the longitudinal axis and parallel to the surface of the piston head, wherein collectively the top surfaces of the plurality of walls defines a wall surface area, and wherein collectively each of the plurality of channels define a channel surface area measured along the surface of the piston head, wherein a ratio of the wall surface area to the channel surface area is at least 1:1.25.

10. The piston assembly of claim 9, wherein the ratio of the wall surface area to the channel surface area is at least 1:2.

11. The piston assembly of claim 8, wherein collectively the plurality of walls circumferentially extends around the longitudinal axis less than 240 degrees.

12. The piston assembly of claim 8, wherein the plurality of walls includes a first set of walls and a second set of walls, wherein the first set of walls receive the plurality of fasteners to couple the piston head to the piston skirt, and wherein the second set of walls do not receive the plurality of fasteners.

13. The piston assembly of claim 8, wherein the plurality of fasteners includes a first pair and a second pair, wherein the first pair of fasteners is spaced at least 110 degrees from the second pair with respect to the longitudinal axis.

14. A piston assembly for an internal combustion engine, the piston assembly comprising:
a piston skirt extending along a longitudinal axis from a first end to a second end, wherein the first end faces a combustion chamber, and the second end faces away from the combustion chamber;
a piston head coupled to the first end of the piston skirt;
a wrist pin bore extending through the piston skirt, the wrist pin bore extending along a wrist pin axis intersecting the longitudinal axis;
a fastener axis perpendicular to the wrist pin axis and to the longitudinal axis;
a plurality of fasteners coupling the piston head to the piston skirt, wherein each of the fasteners of the plurality of fasteners is within 45 circumferential degrees of the fastener axis with respect to the longitudinal axis;
an inner gallery defined between the piston skirt and the piston head, wherein the inner gallery is radially closer to the longitudinal axis than the plurality of fasteners;
an outer gallery defined between the piston skirt and the piston head, wherein the outer gallery is radially further from the longitudinal axis than the plurality of fasteners;
an inlet providing fluid communication for oil between an area within the piston skirt and the outer gallery;
a plurality of channels providing fluid communication between the inner gallery and the outer gallery; and
an outlet providing fluid communication for oil between the outer gallery and the area within the piston skirt.

15. The piston assembly of claim 14, wherein each of the plurality of fasteners is within 30 circumferential degrees from the fastener axis with respect to the longitudinal axis.

16. The piston assembly of claim 14, wherein the piston head comprises a first material and the piston skirt comprises a second material, wherein the first material has a greater stiffness than the second material.

17. The piston assembly of claim 16, wherein the first material comprises steel and the second material comprises aluminum.

18. The piston assembly of claim 14, wherein the first end of the piston skirt comprises a plurality of pads which extend from the first end towards the piston head, and the piston head includes a plurality of walls which extend from the piston head towards the piston skirt, wherein the pads of the piston skirt are coupled to the walls of the piston head and define the plurality of channels.

19. The piston assembly of claim 18, wherein the plurality of walls of the piston head and the plurality of pads of the piston skirt are the same size and shape as each other.

20. The piston assembly of claim 14, wherein each of the plurality of channels includes a first portion and a second portion that is radially closer to the longitudinal axis than the first portion, wherein the first portion has a greater cross-sectional area than the second portion.
